(19) United States
(12) Patent Application Publication
(10) Pub. No.: US 2026/0311414 A1
(43) Pub. Date: Oct. 8, 2026

(54) ON-DEVICE WEB PROXY ARCHITECTURE AND PACING FOR 3D ASSET FETCHING

(71) Applicant: QUALCOMM Incorporated, San Diego, CA (US)

(72) Inventors: Saadallah KASSIR, San Diego, CA (US); Yih-Hao Lin, San Diego, CA (US); Peerapol Tinnakornsrisuphap, San Diego, CA (US); Prashanth Haridas Hande, San Diego, CA (US); Ravi Agarwal, San Diego, CA (US); Simone Merlin, San Diego, CA (US)

(21) Appl. No.: 19/173,534

(22) Filed: Apr. 8, 2025

(51) Int. Cl. G06T 15/00; G06F 9/54

(52) U.S. Cl. CPC G06T 15/005; G06F 9/547; G06T 2210/36

(57) ABSTRACT

This disclosure provides an extended reality device, including a display, one or more positioning sensors, one or more memories storing computer-executable instructions for a proxy, and at least one processor configured to execute the computer-executable instructions. The proxy receives a request for an index file of virtual objects from a web browser executing on the at least one processor and configured to render the virtual objects within the web browser. The proxy obtains, from a web server, the index file, which is accessible to both the web browser and the proxy. The proxy prefetches a virtual object selected from the index file based on one or more hardware-specific properties of the extended reality device. The proxy receives a request for the virtual object from the web browser. The proxy outputs the prefetched virtual object to the web browser.

### TECHNICAL FIELD

The present disclosure relates to 3D asset fetching for extended reality (XR) devices including augmented reality (AR) devices and virtual reality (VR) devices.

### DESCRIPTION OF THE RELATED TECHNOLOGY

Extended reality utilizes a display, usually as part of a headset, to display objects in relation to a field of view of a user. Conventional XR devices have utilized local processing and storage of object resources to generate visual representations of the objects on the display. Access to remote resources for XR may improve user experience by shifting the storage location of resources and expanding the range of available objects to provide more dynamic XR experiences while making XR applications more lightweight.

The use of remote resources for XR, however, raises an issue of communications latency. In order to provide high levels of quality of service (QoS) or quality of experience (QoE) for XR devices, communications must be low latency, high reliability, high bandwidth, and low power consumption.

Additionally, two main deployment scenarios for XR applications include native applications and web applications. Native applications are downloaded to an XR device and designed for the specific device and operating system. While native applications can be optimized for a particular device, the limitation to the specific device reduces adoption of native applications. Web applications may run in generic browsers of XR devices, which can simply design and provide cost efficiency. However, web applications may not have access to features provided by the internal hardware and operating system of the XR device.

WebXR is a device application programming interface (API) aiming at providing device/hardware-specific features to web browsers to be consumed by web apps. Data such as hand and head pose for instance can now be consumed by XR web apps. In order to maintain general applicability, browsers are unlikely to make use of hardware-specific information. Accordingly, there is a need XR devices to be able to use hardware-specific information that is not consumed by WebXR.

### SUMMARY

The systems, methods and devices of this disclosure each have several innovative aspects, no single one of which is solely responsible for the desirable attributes disclosed herein.

In some aspects, the techniques described herein relate to an extended reality device, including: a display; one or more positioning sensors; one or more memories storing computer-executable instructions for a proxy; and at least one processor configured to execute the computer-executable instructions to cause the proxy to: receive a request for an index file of virtual objects from a web browser executing on the at least one processor and configured to render the virtual objects within the web browser; obtain, from a web server, the index file, which is accessible to both the web browser and the proxy; prefetch a virtual object selected from the index file based on one or more hardware-specific properties of the extended reality device; receive a request for the virtual object from the web browser; and output the prefetched virtual object to the web browser.

In some aspects, the techniques described herein relate to a method including: receiving a request for an index file of virtual objects from a web browser at a proxy executing on an extended reality device configured to render the virtual objects within the web browser; obtaining, from a web server, the index file, which is accessible to both the web browser and the proxy; prefetching, by the proxy, a virtual object selected from the index file based on one or more hardware-specific properties of the extended reality device; receiving, at the proxy, a request for the virtual object from the web browser; and outputting the prefetched virtual object to the web browser.

In some aspects, the techniques described herein relate to an apparatus including: means for receiving a request for an index file of virtual objects from a web browser at a proxy executing on an extended reality device configured to render the virtual objects within the web browser; means for obtaining, from a web server, the index file, which is accessible to both the web browser and the proxy; means for prefetching, by the proxy, a virtual object selected from the index file based on one or more hardware-specific properties of the extended reality device; means for receiving, at the proxy, a request for the virtual object from the web browser; and means for outputting the prefetched virtual object to the web browser.

In some aspects, the techniques described herein relate to a non-transitory computer-readable medium storing computer-executable instructions that when executed by a processor of an extended reality device cause the processor to: receive a request for an index file of virtual objects from a web browser at a proxy executing on an extended reality device configured to render the virtual objects within the web browser; obtain, from a web server, the index file, which is accessible to both the web browser and the proxy; prefetch, by the proxy, a virtual object selected from the index file based on one or more hardware-specific properties of the extended reality device; receive, at the proxy, a request for the virtual object from the web browser; and output the prefetched virtual object to the web browser.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of an environment of an extended reality (XR) device.

FIG. 2 is a message diagram illustrating an example of a proxy to pre-fetch virtual objects.

FIG. 3 is a message diagram illustrating an example of transmission times for fetched objects.

FIG. 4 is a message diagram illustrating use of a pacing algorithm to improve object fetching.

FIG. 5 is a diagram illustrating an example of congestion control.

FIG. 6 is a diagram illustrating an example of a pacing algorithm utilizing congestion control information.

FIG. 7 is a flowchart of an example method of fetching virtual objects for a XR device.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways.

In some implementations, the accelerator architectures described herein may implement wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth^{®}standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, 6G or further implementations thereof, technology. However, the apparatuses and techniques described herein may be implemented in any device, system or network regardless of compliance any particular standard specification.

Extended reality (XR) utilizing remote resources may utilize either a pixel-streaming architecture or an object-streaming architecture. In a pixel-streaming architecture, rendering is performed on a remote server and video is streamed to the XR device. Pixel streaming allows for high quality rendering, but is expensive to deploy, bandwidth intensive, and latency sensitive at a video frame level. In an object-streaming architecture, rendering is performed locally based on 3D objects being fetched from a stateless hyper-text transfer protocol (HTTP) webserver. The XR device may just fetch objects that are relevant to a given field of view (FoV). The XR device can decide on the level of detail (LoD) to be downloaded. A high LoD provides better graphics quality but larger file sizes that take longer to download. An object-streaming architecture may be cheaper to deploy and more scalable, but may rely on device hardware for rendering and is latency sensitive at the object level.

The WebXR application programming interface (API) may support object-streaming architectures by allowing an XR device to run 3D-rendered scenes and XR applications directly from a web browser. The WebXR API may execute within a browser and allow an XR web application to query the XR device and establish an XR session. WebXR, however, is not a rendering technology and does not provide features for managing 3D data or rendering it to the display. The browser may also support WebGL for rendering the 3D objects on the display of the XR device. In a WebXR deployment, the browser may be responsible for fetching the 3D objects to render. The browser may obtain a fetch index file from a server that includes a list of objects and metadata of the available objects. The browser may utilize the XR session to obtain motion data and determine new pose data. The browser may then determine a viewpoint and a FoV and fetch objects from the index file data that are within the FoV. For example, fetching may include sending an HTTP request over transmission control protocol (TCP) and receiving an HTTP response, The browser may then render a new scene including objects in the FoV.

Because WebXR and supporting browsers are designed to be compatible with various XR devices, the browser may utilize simple algorithms for fetching objects. For example, a browser may simply fetch any objects within a current FoV. Depending on hardware-specific characteristics, the order and timing of object requests may impact user experience. For example, requesting a large object may delay requests for or delivery of smaller objects that may be important to a scene. Thus, certain issues may arise in fetching objects, e.g., as a result of differences in XR device hardware.

The present disclosure provides an on-device proxy that handles requests to fetch objects. The on-device proxy may communicate with XR device hardware to obtain hardware-specific information useful for pre-fetching objects. The on-device proxy may provide pre-fetched objects to the browser upon request. In some implementations, the on-device proxy may utilize a pacing algorithm based on characteristics of a communications link. The pacing algorithm may reduce latency and congestion. In some implementations, the pacing algorithm may be implemented by the web-application, the browser, or a device operating system.

Several aspects of an on-device proxy and pacing algorithms will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

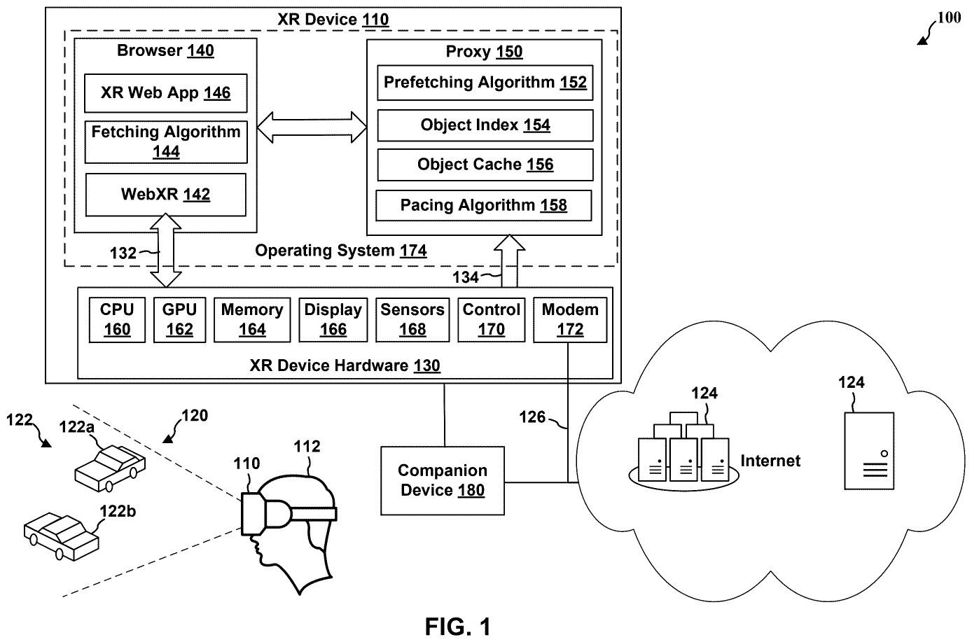

FIG. 1 is a diagram illustrating an example of an environment 100 of an extended reality (XR) device 110. The XR device 110 may be, for example, an augmented reality (AR) device, a virtual reality (VR) device, or a mixed reality (MR) device. The XR device 110 may be an XR headset worn on a head of a user 112. The XR device 110 may render objects 122 relative to a field of view (FoV) 120 of the user 112. For example, the objects 122 may include a first object 122a and a second object 122b. As the user 112 changes head position, the FoV 120 may change and an object 122 may move out of a field of view and a new object may move into the FoV 120. The objects 122 may be stored on a remote server 124. For example, the remote server 124 may be a server in a datacenter or an individual server. The XR device 110 may communicate with the remote server 124 via a network connection 126. For instance, communications may utilize HTTP request and response message. In some implementations, the network connection 126 may include a wireless connection.

In some implementations, the XR device 110 may be connected to one or more companion devices 180. For instance, the companion device 180 may be a user equipment (UE), mobile station (STA), access point (AP), gaming console, etc. The network connection 126 may include the companion device 180. For example, the XR device 110 may communicate with the companion device 180 via a first wired or wireless connection, then the companion device 180 may forward communications to or from the remote server 124.

The XR device 110 includes XR device hardware 130. The XR device hardware 130 can include a display 166, a graphics processing unit (GPU) 162, a central processing unit (CPU) 160, memory 164 (e.g., random access memory (RAM)) and storage (e.g., solid state). The XR device hardware 130 can include positioning sensors 168 such as inertial measurement units (IMUs) and eye tracking sensors. The XR device hardware 130 can include communications components such as a modem 172 or network interface. In some implementations, the XR device hardware 130 includes a hand control 170, which may include a hand-held or hand-worn controller, which may include its own positioning sensors and/or buttons.

The XR device 110 includes a browser 140 that executes on a processor (e.g., the CPU) of the XR device 110. The browser 140 may include a WebXR API 142 that communicates with the XR device hardware 130. For instance, the WebXR API 142 may define some inputs 132 that can be communicated within a WebXR session. For instance, the XR inputs 132 may include pose information and input from hand devices. Other example inputs may include audio data. The WebXR API 142 may provide the XR inputs 132 to a XR web application 146 and/or a fetching algorithm 144.

The XR web application 146 includes software that executes within the browser 140. The XR web application 146 may select objects 122 to render and may control interactions between the user 112 and the objects 122. For instance, an object 122 may respond to an action of the user indicated via a hand device.

The fetching algorithm 144 may include software that executes within the browser 140. In some implementations, the fetching algorithm 144 may be implemented by the XR web application 146. The fetching algorithm 144 may fetch objects 122 required by the XR web application 146. The objects may be selected from an object index 154, for example, based on a position of the object 122 being within the FoV 120. The fetching algorithm 144 may be limited based on the XR inputs 132 available via the WebXR API 142.

In an aspect, the present disclosure provides an on-device proxy 150 that can control object fetching. The on-device proxy 150 may include software executed on the XR device hardware. For example, the on-device proxy 150 may be executed on the CPU 160 at the application layer or in the operating system 174. The on-device proxy may obtain hardware-specific properties 134 from the XR device hardware 130. The hardware-specific properties 134 may include information that is not available via the WebXR API 142. For example, the hardware-specific properties 134 may include predictive positioning information. In some implementations, the hardware-specific properties 134 may include communications parameters such as a link quality of data rate for a wireless connection. In some implementations, the hardware-specific properties 134 may include rendering capabilities of the XR device hardware 130 such as a maximum resolution, level of detail, number of objects, or.

The proxy 150 includes a prefetching algorithm 152 configured to autonomously fetch objects prior to input from the XR Web app 146. The proxy 150 may obtain the object index 154 at the same time as the XR web app 146. For example, the proxy 150 may copy the object index 154 as the HTTP response carrying the object index 154 passes through the proxy 150 to the XR web app 146. The prefetching algorithm 152 may leverage inputs from other device-specific modules included in the hardware-specific properties 134. Example inputs to the prefetching algorithm 152 may include rendering capabilities that indicate how long it takes for the XR device 110 to render a scene or an object, head pose or position tracking information, transport layer throughput, or server round-trip time (RTT). The prefetching algorithm 152 may utilize the same HTTP request/response mechanism for prefetching objects 122. The prefetching algorithm may store the received objects in an object cache 156 until the XR web app 146 requests the objects. If the XR web app 146 requests an object that is not stored in the object cache 156, the prefetching algorithm 152 may immediately request the object.

In some implementations, the proxy 150 includes a pacing algorithm 158. The pacing algorithm 158 is configured to set the timing of object requests based on communications parameters such as object file size, data rate, and congestion information. For instance, the pacing algorithm 158 may transmit an object request such that the request is received at the server 124 as the server finishes sending a previous object. The pacing algorithm may allow the XR device 110 to maximize throughput of available communication resources without causing congestion while also allowing requests for the most relevant object closer to the time of delivery.

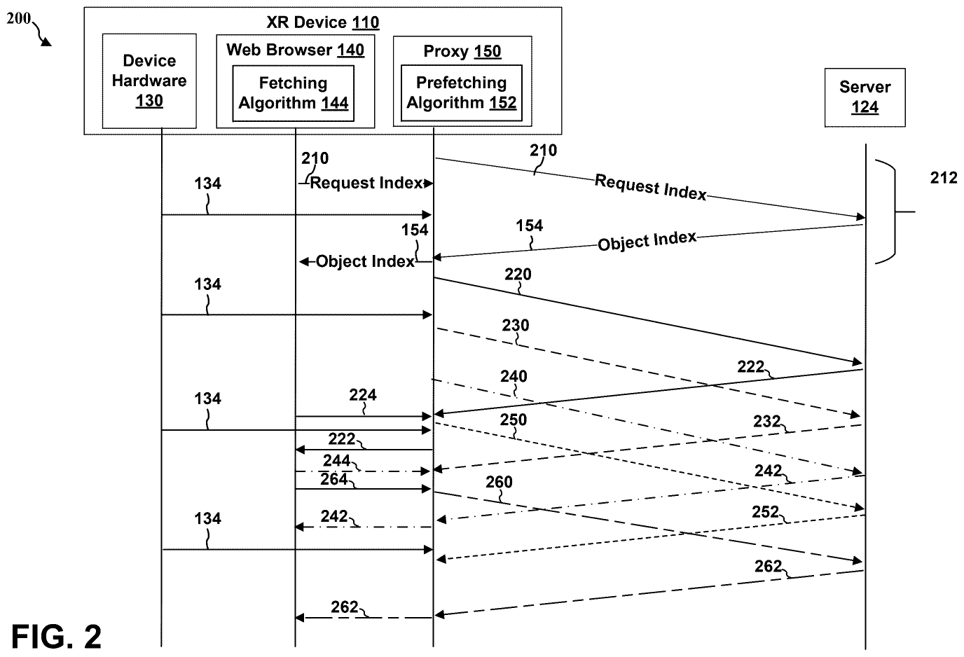

FIG. 2 is a message diagram 200 illustrating an example use of a proxy 150 to fetch objects for an XR device 110. In an implementation, requests by the web browser 140 (or web app 146) may pass through the proxy 150. For instance, the fetching algorithm 144 may generate a request 210 for an object index 154 and/or requests 224, 244, or 264 for specific objects. The device hardware 130 may periodically provide hardware-specific properties 134 to the proxy 150, for use by the prefetching algorithm 152.

The web browser 140 may initially send a request 210 for an object index 154. The proxy 150 may receive the request 210 and transmit the request as an HTTP request 210 for an object index. The server 124 may receive the request 210 and provide an HTTP response including the object index 154. The time between transmitting the request 210 and receiving the object index 154 may be considered a round-trip time (RTT) 212. The proxy 150 may store the object index 154 and also provide the object index 154 to the web browser 140.

The prefetching algorithm 152 of the proxy 150 may request objects based on the object index 154 and the hardware-specific properties 134. For example, the prefetching algorithm 152 may transmit a request 220 for a first object prior to receiving a request from the web browser 140 or fetching algorithm 144 for the first object. The proxy 150 may expect to receive the first object 222 after approximately one RTT 212. The actual RTT for each request may vary depending on communications conditions and file size. In some implementations, the proxy 150 may request additional objects during the RTT. For example, the proxy 150 may transmit a request 230 for a second object 232 and a request 240 for a third object 242 before receiving the first object 222. The proxy 150 may receive the first object 222 before a request 224 for the first object is received from the web browser 140. The proxy 150 may store the first object 222 in the object cache 156. When the request 224 for the first object is received from the web browser 140, the proxy 150 may immediately respond with the object first object 222 because the first object 222 is already stored in the object cache 156.

The proxy 150 may receive a request 244 for the third object prior to the third object 242 being received from the server 124. The proxy 150 may not need to send a second request for the third object 242 when there is already a pending request 240 for the third object. The proxy 150 may wait until the third object 242 is received, then pass the third object 242 to the web browser 140. When the request from the web browser 140 is received after the prefetch request from the proxy, the time for the web browser 140 to receive the object may be shorter than the RTT 212. In some cases, the proxy may send a request 250 for an object 252 that is never requested by the fetching algorithm 144. Although the request 250 may consume communication resources, a user is unlikely to notice any delay due to the request 250.

The proxy 150 may receive a request 264 for a fifth object 262 that has not been prefetched by the proxy 150. The proxy 150 may transmit a request 260 for the fifth object 262 in response to the request 264. The proxy may pass the fifth object 262 to the web browser upon receipt.

In some implementations, the proxy 150 may provide an indication to the web browser 140 when a new object has been fetched and locally cached. For example, the indication may include a timestamp of the reception of the object and information including a file identifier, object identifier, and LoD of the object. In some implementations, the indication may be provided as an interface of the WebXR API 142. Notification of prefetched objects to the web browser 140 may allow earlier rendering of the objects, which can improve the user experience.

In some implementations, the web browser 140 may adjust the fetching algorithm 144 based on the prefetching algorithm 152 and/or the indication from the proxy 150. For example, the web browser 140 may prioritize objects that have been prefetched. The web browser 140 may automatically request objects that are received at the proxy 150. In some implementations, the web browser 140 may disable the fetching algorithm 144 and rely on the prefetching algorithm 152. For instance, the web browser 140 may provide the object index 154 to the proxy 150, then request objects when receiving a notification from the proxy 150.

In some implementations, the proxy 150 may manage LOD of objects. The proxy 150 could indicate object reception events to the web browser 140, allowing the web browser to adjust its fetching policy, for example, to match the LOD of received objects. If the web browser 140 requests an object with a higher LOD than the same object that has already been prefetched with a lower LOD, the proxy 150 may provide the lower LOD object temporarily until the higher LOD object is fetched. The proxy 150 may implement various policies for fetching higher LOD objects. Option 1: the proxy 150 may prioritize the requested LOD object over other objects in its request pipeline. Option 2: the proxy 150 may decide to add the requested LOD object as the tail of the request queue. Option 3: the proxy 150 may decide not to request the higher LOD object if a lower LOD one has already been returned. For example, if a utility gain of the higher LOD is minimal, wireless resources may be better used for other objects. If the web browser 140 requests a lower LOD than the LOD of an object that has been prefetched, the proxy 150 may return the prefetched object instead and decide not to fetch the lower LOD object. The web browser 140 may configure the proxy 150 with the desired behavior during an initialization stage.

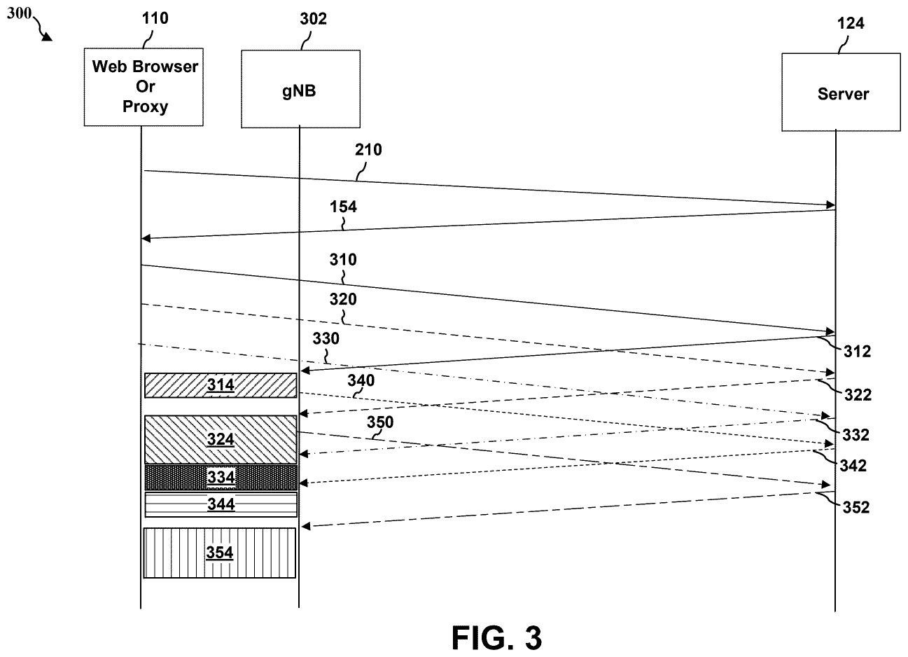

FIG. 3 is a message diagram 300 illustrating an example of transmission times for objects fetched by a XR device 110 over a wireless connection. The concepts presented in FIG. 3 may apply whether objects are fetched directly by the fetching algorithm 144 in the web browser 140 or the prefetching algorithm 152 in the proxy 150.

A wireless connection may include a network node such as a gNB 302. Communication resources between the gNB 302 and the XR device 110 may be limited. For example, the wireless connection may utilize a wireless channel having conditions that vary. There may also be other devices competing for bandwidth resources on the wireless channel. Due to different file sizes for objects 122, transmission times over the wireless connection may vary. This can lead to queuing at the gNB and possible channel underutilization.

In the illustrated example, the XR device 110 may request 210 the object index and receive the object index 154. The XR device 110 may then send requests 310, 320, 330, 340, and 350 for objects. The requests 310, 320, 330, 340, and 350 may be transmitted as soon as the web browser 140 or proxy 150 determines that an object is needed, or may be transmitted periodically. The server 124 may respond to each request 310, 320, 330, 340, and 350 with a respective object 312, 322, 332, 342, and 352. When each object 312, 322, 332, 342, and 352 reaches the gNB 302, the gNB 302 may send a wireless transmission 314, 324, 334, 344, 354 carrying the object to the XR device 110. The transmission times of the wireless transmissions 314, 324, 334, 344, 354 may vary based on the file size and possibly changing channel conditions. A small file size may result in a short transmission such as the wireless transmission 314 and 344. The channel may not be unoccupied following the short transmission, resulting in channel underutilization. In contrast, larger file sizes may result in congestion. For example, the gNB 302 may receive the object 332 prior to completing transmission of the 324. Accordingly, the gNB 302 may need to queue the transmission 334. Additionally, when there is congestion, there is a longer round trip time between the request and the object reaching the XR device 110. In some cases, when an object is delayed, the received object may be stale or have a lower priority than when the object was requested.

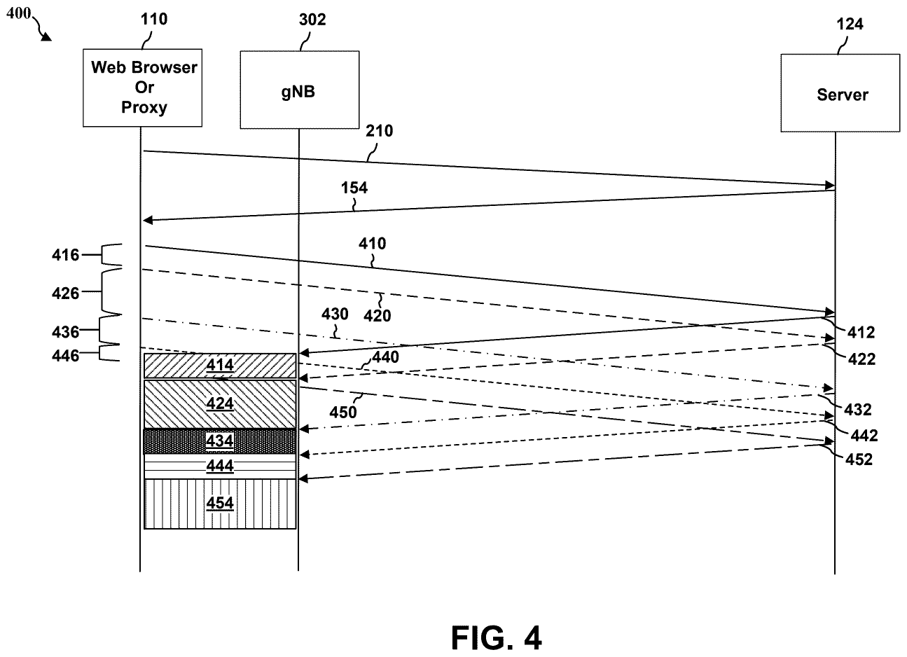

FIG. 4 is a message diagram 400 illustrating use of a pacing algorithm 158 to improve object fetching. In the illustrated example, the XR device 110 may request 210 the object index and receive the object index 154. The XR device 110 may then generate requests 410, 420, 430, 440, and 450 for objects. Instead of transmitting the requests 410, 420, 430, 440, and 450 as soon as generated, the XR device 110 may execute pacing algorithm 158 to control the timing of the requests.

In an example implementation, the pacing algorithm 158 may estimate a file transmission delay to dynamically determine a next request time. For instance, the request time may be selected such that transmission of the next object starts as soon as the previous object has been received. For instance, the inter-request delay may be set to an expected transmission time of the wireless transmission. In some implementations, the web browser 140 and/or proxy 150 may have access to data rate information via the XR inputs 132 or the hardware-specific properties 134.

In the illustrated example, the request 410 is transmitted, then the request 420 is transmitted after a delay 416 that is equal to an expected transmission time of the transmission 414. The delay 416 may be estimated based on the file size and estimated data rate. Similarly, the request 430 may be transmitted with a delay 426 based on the expected transmission time of the transmission 424. The delays 436 and 446 for the requests 440 and 450 may be determined in a similar manner. The server 124 may transmit the requested objects 412, 422, 432, 442, and 452 upon receipt of the requests 410, 420, 430, 440, and 450 without delay. The gNB 302 may receive the objects 412, 422, 432, 442, and 452 and transmit the corresponding wireless transmission 414, 424, 434, 444, 454. If the estimated delays 416, 426, 436, and 446 are accurate, the wireless transmission 414, 424, 434, 444, 454 may not have gaps in between and the gNB 302 may not experience congestion. Accordingly, the total transmission time for the requested objects may be reduced and efficiency improved.

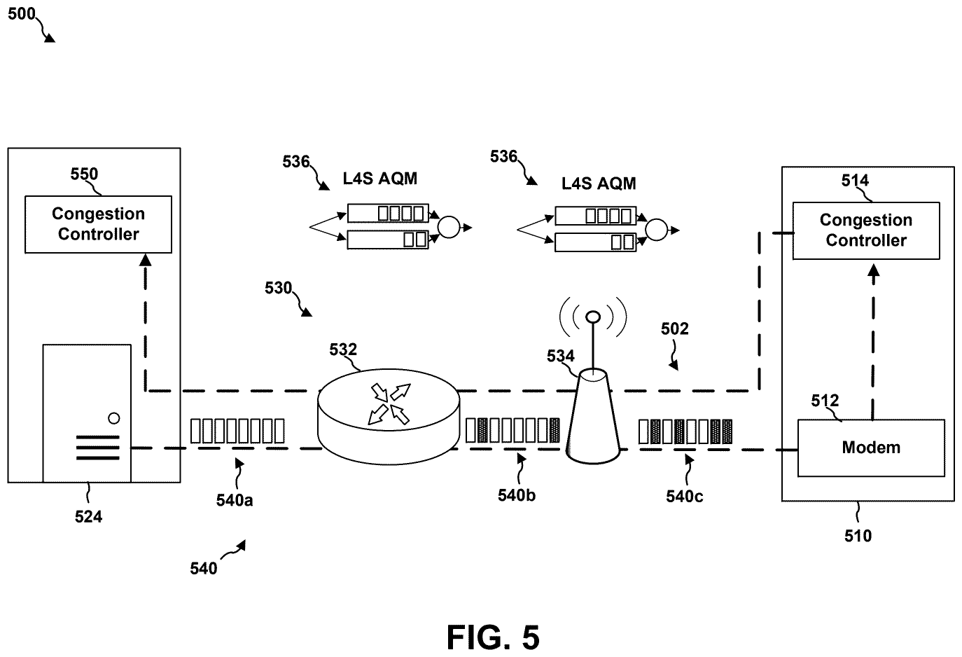

FIG. 5 is a diagram 500 illustrating an example of congestion control for a communications link 502. The communications link 502 may connect a device 510 (e.g., the XR device 110) with a server 524 (e.g., the server 124). In an example, the congestion control may follow the L4S framework defined in RFC 9330. In some implementations, congestion control may provide information for use in the pacing algorithm 158.

The communication link 502 may traverse network nodes 530 such as a router 532 and a gNB 534. Each network node 530 may include an L4S active queue management (AQM) module 536 that provides a separate queue of L4S traffic. In the downlink direction, the server 524 may send a plurality of packets 540. For example, the packets may be IP packets within a flow (i.e., defined by an IP 5-tuple of source address, source port, destination address, destination port, and protocol). Initially, the packets 540 may include an explicit congestion notification (ECN) field that is marked in the IP header as L4S traffic but not congested (i.e., not a value of 11 indicating congestion). As the packets 540 traverse network nodes such as the router 532 or the gNB 534, each network node may mark one or more packets 540 if congestion was experienced. For instance, the packets 540a sent by the server 524 may have no packets marked, the packets 540b forwarded by the router 532 may have a few packets marked, and the packets 540c transmitted by the gNB may have more packets marked. The packets 540 may be received at the modem 512 of the device 510. The modem 512 may determine congestion levels based on the number of marked packets. The modem 512 may provide the marked packets and/or congestion information to a congestion controller 514. In the uplink, the congestion controller 514 may provide feedback regarding the level of congestion to a congestion controller 550 at the server 524.

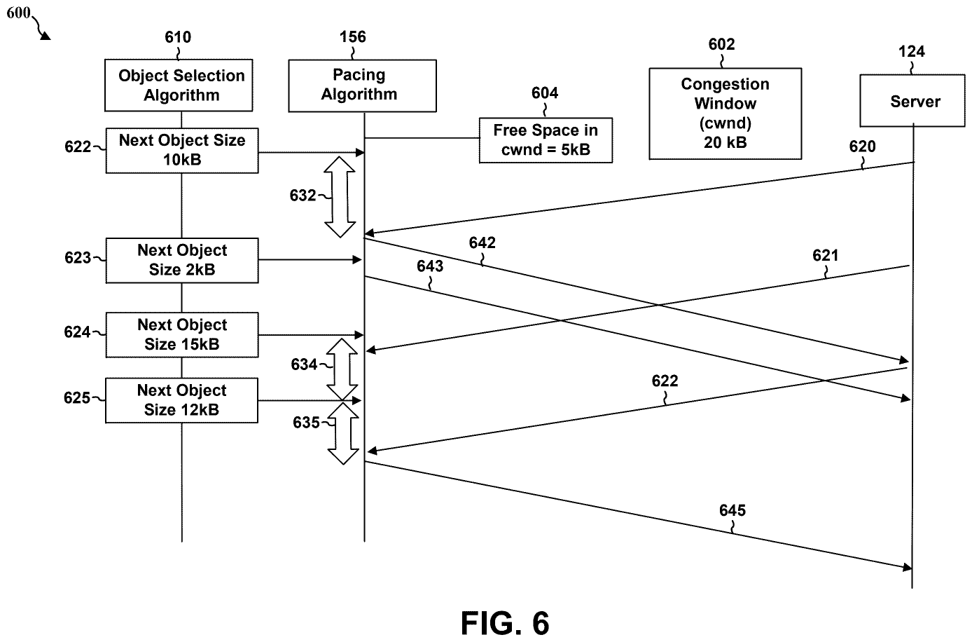

FIG. 6 is a diagram 600 illustrating an example of a pacing algorithm utilizing congestion control information. The pacing algorithm may make use of a congestion window (cwnd) 602. In an implementation the cwnd 602 may be a parameter defined as a maximum number of bytes requested by the HTTP client (e.g., the XR device 110) that have not yet been received. For example, in the illustrated example, the cwnd 602 may be configured as 20 kB.

In an aspect, the web browser 140 or the proxy 150 may inspect IP packets and update the cwnd 602 or remaining free space 604 in the cwnd 602 based on inspected IP packets. An object selection algorithm 610 (which may include the fetching algorithm 144 or the prefetching algorithm 152) may select a next object to fetch based on the cwnd 602 (i.e., taking into account whether size of the object will cause congestion). The pacing algorithm 158 may then transmit a request for the selected object at a transmission time that satisfies congestion control requirements.

In the illustrated example, the cwnd 602 may initially have 5 kB free. For instance, requests for object 620 (8 kB) and object 621 (7 kB) may be pending. The object selection algorithm 610 may select a next object 622 based on relevancy, position, and file size. For instance, the selected object 622 may have a file size of 10 kB, which is larger than the free space in cwnd. The pacing algorithm 158 may delay a request for the object 622 for a period 632 until there is space in the cwnd. For instance, when the object 620 having size of 8 kB is received, the cwnd 602 may have space of 13 kB, so the request 642 for the object 622 may be sent, leaving space of 3 kB. The object selection algorithm may select a next object 623 having a size of 2 kB. The request 643 for the object 623 may be sent without a delay, leaving space of 1 kB in the cwnd 602. The object 621 having size of 7 kB may be received, resulting in space of 8 kB in the cwnd 602.

The object selection algorithm 610 may select object 624 having a size of 15 kB, but the cwnd 602 may not allow the request for the object 624. While the request for the object 624 is delayed during period 634, the object selection algorithm 610 may generate a request for an object 625. In some implementations, the object 625 may be higher priority than the object 624. For example, the object 625 may be a lower LoD version of the object 624, or the object 624 may be moving out of the FoV 120. The request for the object 624 may be canceled and replaced with the request for the object 625. When the object 622 is received, the cwnd 602 may have space of 18 kB free, so the pacing algorithm 158 may send the request 645 for object 625 after the delay 635.

In an aspect, the use of the cwnd 602 to delay requests ensures that the most relevant object is always the next object to be requested. In some cases, delays may create head of line blocking, e.g., when a large file is to be requested but is waiting for space in cwnd 602 to free up, preventing any other request to go through. In some implementations, the object selection algorithm 610 can be made aware of the available space in cwnd 602 and possibly prioritize objects of smaller size for improved user experience. For example, in the illustrated example, object 623 could be requested before 622, while still having object 622 be requested at the same time.

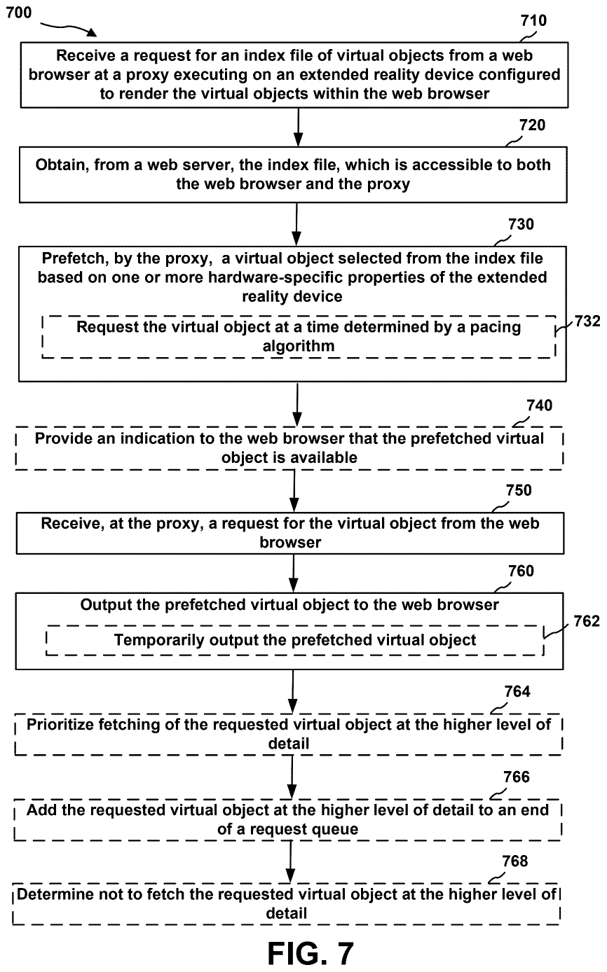

FIG. 7 is a flowchart of an example method 700 of fetching objects for XR. The method 700 may be performed by the XR device 110 or one or more components thereof including the XR device hardware 130. The method 700 may be performed in communication with a web server 124. Optional blocks are shown with dashed lines.

At block 710, the method 700 includes receiving a request for an index file of virtual objects from a web browser at a proxy executing on an extended reality device configured to render the virtual objects within the web browser. In some implementations, for example, the proxy 150 receives a request 210 for an index file (e.g., object index 154) of virtual objects 122 from a web browser 140 at a proxy executing on an extended reality device 110 configured to render the virtual objects within the web browser. In some implementations, the proxy 150 may be executed on the CPU 160 within an operating system 174 or on the modem 172. Accordingly, the CPU 160 or the modem 172 executing the proxy 150 may provide means for receiving a request for an index file of virtual objects from a web browser at a proxy executing on an extended reality device configured to render the virtual objects within the web browser.

At block 720, the method 700 includes obtaining, from the web server, the index file, which is accessible to both the web browser and the proxy. In some implementations, for example, the proxy 150 may obtain from the web server 124, the object index 154, which is accessible to both the web browser 140 and the proxy 150. For example, the proxy 150 may transmit the request 210 as an HTTP request and receive the object index 154 in an HTTP response. Accordingly, the CPU 160 or the modem 172 executing the proxy 150 may provide means for obtaining, from a web server, the index file, which is accessible to both the web browser and the proxy.

At block 730, the method 700 includes prefetching, by the proxy, a virtual object selected from the index file based on one or more hardware-specific properties of the extended reality device. In some implementations, for example, the proxy 150 and/or the prefetching algorithm 152 may prefetch a virtual object 122 selected from the index file based on one or more hardware-specific properties 134 of the extended reality device 110. In some implementations, the one or more hardware-specific properties are not available within an API (e.g., WebXR API 142) defined between the web browser 140 and an operating system 174 of the extended reality device 110.

In some implementations, at sub-block 732, the block 730 may optionally include requesting the virtual object at a time determined by the pacing algorithm 158. Accordingly, the CPU 160 or the modem 172 executing the proxy 150 and/or the prefetching algorithm 152 may provide means for prefetching a virtual object selected from the index file based on one or more hardware-specific properties of the extended reality device.

At block 740, the method 700 may optionally include providing an indication to the web browser that the prefetched virtual object is available. In some implementations, for example, the proxy 150 and/or the prefetching algorithm 152 may provide an indication to the web browser 140 that the prefetched virtual object is available. Accordingly, the CPU 160 or the modem 172 executing the proxy 150 and/or the prefetching algorithm 152 may provide means for providing an indication to the web browser that the prefetched virtual object is available.

At block 750, the method 700 may optionally include receiving, at the proxy, a request for the virtual object from the web browser. In some implementations, for example, the proxy 150 and/or the object cache 156 may receive a request 224 for the virtual object from the web browser 140. Accordingly, the CPU 160 or the modem 172 executing the proxy 150 and/or the object cache 156 may provide means for receiving, at the proxy, a request for the virtual object from the web browser.

At block 760, the method 700 may include outputting the prefetched virtual object to the web browser. In some implementations, for example, the proxy 150 and/or the object cache 156 may output the prefetched virtual object 222 to the web browser 140. Accordingly, the CPU 160 or the modem 172 executing the proxy 150 and/or the object cache 156 may provide means for outputting the prefetched virtual object to the web browser.

In some implementations, at sub-block 762, the block 760 may optionally include temporarily outputting the prefetched virtual object. For example, proxy may execute the sub-block 762 when a level of detail of the requested virtual object is higher than a level of detail of the prefetched virtual object. The proxy 150 and/or the object cache 156 may output the prefetched virtual object with an indication that the returned object is temporary. The proxy 150 may then execute one of blocks 764, 766, or 768. For example, in block 764, the proxy 150 may prioritize fetching of the requested virtual object at the higher level of detail. For instance, the proxy 150 may transmit an HTTP request for the requested virtual object at the higher level of detail at the next available opportunity (e.g., controlled by the pacing algorithm 158). The proxy may provide the requested virtual object at the higher level of detail once it is received. In block 766, the proxy 150 may add the requested virtual object at the higher level of detail to an end of a request queue. For instance, the higher level of detail may be considered a low priority as the temporary object is available. In block 768, the proxy 150 may determine not to fetch the requested virtual object at the higher level of detail.

The following numbered clauses provide an overview of aspects of the present disclosure:
Clause 1. An extended reality device, comprising: a display; one or more positioning sensors; one or more memories storing computer-executable instructions for a proxy; and at least one processor configured to execute the computer-executable instructions to cause the proxy to: receive a request for an index file of virtual objects from a web browser executing on the at least one processor and configured to render the virtual objects within the web browser; obtain, from a web server, the index file, which is accessible to both the web browser and the proxy; prefetch a virtual object selected from the index file based on one or more hardware-specific properties of the extended reality device; receive a request for the virtual object from the web browser; and output the prefetched virtual object to the web browser.
Clause 2. The extended reality device of clause 1, wherein the proxy is further configured to provide an indication to the web browser that the prefetched virtual object is available.
Clause 3. The extended reality device of clause 1 or 2, wherein a level of detail of the requested virtual object is higher than a level of detail of the prefetched virtual object, wherein the proxy is configured to temporarily output the prefetched virtual object.
Clause 4. The extended reality device of any of clauses 1-3, wherein the proxy is executed by a central processing unit of the extended reality device at an application layer or within an operating system of the extended reality device.
Clause 5. The extended reality device of any of clauses 1-4, wherein the one or more hardware-specific properties are not available within a WebXR application programming interface (API) defined between the web browser and an operating system of the extended reality device.
Clause 6. The extended reality device of any of clauses 1-5, wherein the one or more hardware-specific properties include at least one of: predictive positioning information; rendering capabilities of the extended reality device; or communications parameters.
Clause 7. The extended reality device of any of clauses 1-6, wherein the at least one processor is configured to execute the proxy, the web browser, or an operating system to request the virtual object at a time determined by a pacing algorithm.
Clause 8. The extended reality device of clause 7, wherein the at least one processor is configured to execute an event-based object selection algorithm that selects the virtual object at the determined time.
Clause 9. The extended reality device of clause 7, wherein the at least one processor is configured to execute a periodic object selection algorithm that periodically selects a next virtual object and requests the next virtual object at the determined time.
Clause 10. The extended reality device of clause 7, wherein an object selection algorithm selects a virtual object with a size within a congestion window.
Clause 11. A method comprising: receiving a request for an index file of virtual objects from a web browser at a proxy executing on an extended reality device configured to render the virtual objects within the web browser; obtaining, from a web server, the index file, which is accessible to both the web browser and the proxy; prefetching, by the proxy, a virtual object selected from the index file based on one or more hardware-specific properties of the extended reality device; receiving, at the proxy, a request for the virtual object from the web browser; and outputting the prefetched virtual object to the web browser.
Clause 12. The method of clause 11, further comprising providing an indication to the web browser that the prefetched virtual object is available.
Clause 13. The method of clause 11 or 12, wherein a level of detail of the requested virtual object is higher than a level of detail of the prefetched virtual object, wherein outputting the prefetched virtual object to the web browser comprises temporarily outputting the prefetched virtual object.
Clause 14. The method of clause 13, further comprising prioritizing fetching of the requested virtual object at the higher level of detail.
Clause 15. The method of clause 13, further comprising adding the requested virtual object at the higher level of detail to an end of a request queue.
Clause 16. The method of clause 13, further comprising determining not to fetch the requested virtual object at the higher level of detail.
Clause 17. The method of any of clauses 11-16, wherein prefetching comprises requesting the virtual object at a time determined by a pacing algorithm.
Clause 18. The method of clause 17, wherein the pacing algorithm is an event-based object selection algorithm that selects the virtual object at the determined time.
Clause 19. The method of clause 17, wherein the pacing algorithm is a periodic object selection algorithm that periodically selects a next virtual object and requests the next virtual object at the determined time.
Clause 20. An apparatus comprising: means for receiving a request for an index file of virtual objects from a web browser at a proxy executing on an extended reality device configured to render the virtual objects within the web browser; means for obtaining, from a web server, the index file, which is accessible to both the web browser and the proxy; means for prefetching, by the proxy, a virtual object selected from the index file based on one or more hardware-specific properties of the extended reality device; means for receiving, at the proxy, a request for the virtual object from the web browser; and means for outputting the prefetched virtual object to the web browser.
Clause 21. The apparatus of clause 21, further comprising means for performing any of the method of any of clauses 12-20
Clause 22. A non-transitory computer-readable medium storing computer-executable instructions that when executed by a processor of an extended reality device cause the processor to: receive a request for an index file of virtual objects from a web browser at a proxy executing on an extended reality device configured to render the virtual objects within the web browser; obtain, from a web server, the index file, which is accessible to both the web browser and the proxy; prefetch, by the proxy, a virtual object selected from the index file based on one or more hardware-specific properties of the extended reality device; receive, at the proxy, a request for the virtual object from the web browser; and output the prefetched virtual object to the web browser.
Clause 23. The non-transitory computer-readable medium of clause 22, further comprising means for performing any of the method of any of clauses 12-20.

As used herein, a phrase referring to “at least one of” a list of items refers to any combination of those items, including single members. As an example, “at least one of: a, b, or c” is intended to cover: a, b, c, a-b, a-c, b-c, and a-b-c. Similarly, as used herein, a phrase referring to “one or more of” a list of items refers to any combination of those items, including single members. As an example, “one or more of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An extended reality device, comprising:
a display;
one or more positioning sensors;
one or more memories storing computer-executable instructions for a proxy; and
at least one processor configured to execute the computer-executable instructions to cause the proxy to:
receive a request for an index file of virtual objects from a web browser executing on the at least one processor and configured to render the virtual objects within the web browser;
obtain, from a web server, the index file, which is accessible to both the web browser and the proxy;
prefetch a virtual object selected from the index file based on one or more hardware-specific properties of the extended reality device;
receive a request for the virtual object from the web browser; and
output the prefetched virtual object to the web browser.

2. The extended reality device of claim 1, wherein the proxy is further configured to provide an indication to the web browser that the prefetched virtual object is available.

3. The extended reality device of claim 1, wherein a level of detail of the requested virtual object is higher than a level of detail of the prefetched virtual object, wherein the proxy is configured to temporarily output the prefetched virtual object.

4. The extended reality device of claim 1, wherein the proxy is executed by a central processing unit of the extended reality device at an application layer or within an operating system of the extended reality device.

5. The extended reality device of claim 1, wherein the one or more hardware-specific properties are not available within a WebXR application programming interface (API) defined between the web browser and an operating system of the extended reality device.

6. The extended reality device of claim 1, wherein the one or more hardware-specific properties include at least one of:
predictive positioning information;
rendering capabilities of the extended reality device; or
communications parameters.

7. The extended reality device of claim 1, wherein the at least one processor is configured to execute the proxy, the web browser, or an operating system to request the virtual object at a time determined by a pacing algorithm.

8. The extended reality device of claim 7, wherein the at least one processor is configured to execute an event-based object selection algorithm that selects the virtual object at the determined time.

9. The extended reality device of claim 7, wherein the at least one processor is configured to execute a periodic object selection algorithm that periodically selects a next virtual object and requests the next virtual object at the determined time.

10. The extended reality device of claim 7, wherein an object selection algorithm selects a virtual object with a size within a congestion window.

11. A method comprising:
receiving a request for an index file of virtual objects from a web browser at a proxy executing on an extended reality device configured to render the virtual objects within the web browser;
obtaining, from a web server, the index file, which is accessible to both the web browser and the proxy;
prefetching, by the proxy, a virtual object selected from the index file based on one or more hardware-specific properties of the extended reality device;
receiving, at the proxy, a request for the virtual object from the web browser; and
outputting the prefetched virtual object to the web browser.

12. The method of claim 11, further comprising providing an indication to the web browser that the prefetched virtual object is available.

13. The method of claim 11, wherein a level of detail of the requested virtual object is higher than a level of detail of the prefetched virtual object, wherein outputting the prefetched virtual object to the web browser comprises temporarily outputting the prefetched virtual object.

14. The method of claim 13, further comprising prioritizing fetching of the requested virtual object at the higher level of detail.

15. The method of claim 13, further comprising adding the requested virtual object at the higher level of detail to an end of a request queue.

16. The method of claim 13, further comprising determining not to fetch the requested virtual object at the higher level of detail.

17. The method of claim 11, wherein prefetching comprises requesting the virtual object at a time determined by a pacing algorithm.

18. The method of claim 17, wherein the pacing algorithm is an event-based object selection algorithm that selects the virtual object at the determined time.

19. The method of claim 17, wherein the pacing algorithm is a periodic object selection algorithm that periodically selects a next virtual object and requests the next virtual object at the determined time.

20. An apparatus comprising:
means for receiving a request for an index file of virtual objects from a web browser at a proxy executing on an extended reality device configured to render the virtual objects within the web browser;
means for obtaining, from a web server, the index file, which is accessible to both the web browser and the proxy;
means for prefetching, by the proxy, a virtual object selected from the index file based on one or more hardware-specific properties of the extended reality device;
means for receiving, at the proxy, a request for the virtual object from the web browser; and
means for outputting the prefetched virtual object to the web browser.
